(19) United States
(12) Patent Application Publication
(10) Pub. No.: US 2021/0129608 A1
(43) Pub. Date: May 6, 2021

(54) Trailer Coupler For Tow Ball

(71) Applicant: Curt Manufacturing, LLC, Eau Claire, WI (US)

(72) Inventors: Curtis M. Bowe, Chippewa Falls, WI (US); Robert G. Fehr, Colfax, WI (US)

(21) Appl. No.: 17/086,685

(22) Filed: Nov. 2, 2020

Related U.S. Application Data
(60) Provisional application No. 62/928,719, filed on Oct. 31, 2019.

(51) Int. Cl. B60D 1/28; B60D 1/06; B60D 1/48

(52) U.S. Cl. CPC B60D 1/28; B60D 1/48; B60D 1/065

(57) ABSTRACT

A trailer coupler body is formed from sheet metal with walls defining a recess having a contact surface for bearing against the tow ball during towing. A latch pin opening is positioned in the right side wall and the left side wall of the trailer coupler body behind the recess and lower than the tow ball equator. A latch pin reinforcement crossmember is separately formed from sheet metal, and welded to extend between the right and left side walls adjacent the latch pin opening. When a latch pin is transversely inserted into the latch pin opening, it contacts the tow ball and holds the tow ball in place within the trailer coupler recess, in a position where the latch pin reinforcement crossmember will support the latch pin against deflection opposite the tow ball due to towing forces transmitted to or from the tow ball.

### CROSS-REFERENCE TO RELATED APPLICATION(S)

The present application claims the benefit of U.S. provisional patent application Ser. No. 62/928,719, filed Oct. 31, 2019, entitled “Trailer Coupler For Tow Ball”. The contents of U.S. provisional patent application Ser. No. 62/928,719 are hereby incorporated by reference in entirety.

### BACKGROUND OF THE INVENTION

The present application relates to couplers used on the front of trailers or similar loads towed using a hitch ball off the back of a towing vehicle.

Ball hitches are commonly used in towing, in connecting a trailer or similar load behind a towing vehicle. In general, the spherically-shaped tow ball is mounted off the rear bumper or rearwardly-facing hitch of the towing vehicle and is received within a spherically-shaped recess of a coupler. The spherical bearing surfaces of the tow ball and coupler define a towing pivot point about which the coupler can articulate relative to the ball, allowing the trailer to change its angle relative to the towing vehicle while traversing over different grades, sideslopes and turns. Trailer couplers typically include not only a recess contacting the front surface of the ball, but also some sort of latching mechanism, which enables the coupler to be attachable and detachable from the tow ball, and while attached prevents the coupler from inadvertantly becoming separated from the ball during towing.

Trailer couplers tend to be used over a long product life cycle, potentially including outside storage for years or decades. Jamming and rusting of a latch mechanism over time is a significant problem. The couplers need to be reliable in attaching to the tow ball, as catastrophic accidents could occur should the trailer inadvertently come loose during towing after a false coupling. The use of tools and/or significant forces (such as through kicking) during coupling and decoupling should be avoided. The trailer couplers must also be low in cost, and should be as light as possible in weight. U.S. Pat. Nos. 6,000,710, 7,017,935, 7,425,016 and 7,735,850 show prior art trailer couplers, and are all incorporated by reference for their teaching of the problem. Better solutions are needed.

### SUMMARY OF THE INVENTION

The present invention is a trailer coupler for use with a tow ball, as well as a method of making the trailer coupler. The walls of the trailer coupler define a recess having a contact surface for bearing against the tow ball during towing. The right side wall and the left side wall of the trailer coupler define a latch pin opening lower than the tow ball equator, and a latch pin reinforcement crossmember extends between the right and left side walls adjacent the latch pin opening. In one aspect, both the trailer coupler and its latch pin reinforcement crossmember are formed from stamped and bent sheet metal and welded together. When a latch pin is transversely inserted into the latch pin opening, it contacts the tow ball and holds the tow ball in place within the trailer coupler recess, in a position where the latch pin reinforcement crossmember will support the latch pin against deflection opposite the tow ball due to towing forces transmitted to or from the tow ball.

### BRIEF DESCRIPTION OF THE DRAWINGS

The present invention is described with reference to the attached drawing sheets, in which:

FIG. 1 is a perspective view of a first preferred trailer coupler in accordance with the present invention.

FIG. 2 is a perspective view showing the underside of the trailer coupler of FIG. 1.

FIG. 3 is a top plan view showing the trailer coupler of FIGS. 1 and 2 in a latched configuration.

FIG. 4 is a cross-sectional view, taken along cut lines 4-4 in FIG. 3, latched onto a representation of a tow ball.

FIG. 5 is a plan view of a flat pattern used for making the pin reinforcement crossmember of the coupler of FIGS. 1-4.

FIG. 6 is a perspective view of the pin reinforcement crossmember of FIG. 5 after bending.

FIG. 7 is a top plan view of the pin reinforcement crossmember of FIG. 6.

FIG. 8 is an end view of the pin reinforcement crossmember of FIGS. 6 and 7.

FIG. 9 is a perspective view of a second embodiment of a trailer coupler weldment in accordance with the present invention.

FIG. 10 is a top plan view of the trailer coupler weldment of FIG. 9.

FIG. 11 is a side view of the trailer coupler weldment of FIGS. 9 and 10.

FIG. 12 is a cross-sectional view of the trailer coupler weldment, taken along cut lines 12-12 in FIG. 10.

FIG. 13 is a perspective exploded assembly view of a third embodiment of a trailer coupler in accordance with the present invention.

FIG. 14 is a top plan view of the trailer coupler of FIG. 13 in a latched configuration, but not showing the lanyard.

FIG. 15 is a cross-section view, taken along cut lines 15-15 in FIG. 14, latched onto a representation of a tow ball.

FIG. 16 is a perspective view showing the underside of a fourth embodiment of a trailer coupler weldment in accordance with the present invention.

FIG. 17 is a top plan view of the trailer coupler weldment of FIG. 16.

FIG. 18 is a side view of the trailer coupler weldment of FIGS. 16 and 17.

FIG. 19 is a cross-sectional view of the trailer coupler weldment, taken along cut lines 19-19 in FIG. 17.

FIG. 20 is an exploded perspective view showing the underside of a fifth embodiment of a trailer coupler weldment in accordance with some aspects of the present invention.

FIG. 21 is a cross-sectional view of the coupler head of the trailer coupler weldment of FIG. 20, taken along cut lines 21-21 in FIG. 20.

FIG. 22 is a cross-sectional view of the coupler head of the trailer coupler weldment of FIG. 20, taken along cut lines 22-22 in FIG. 20.

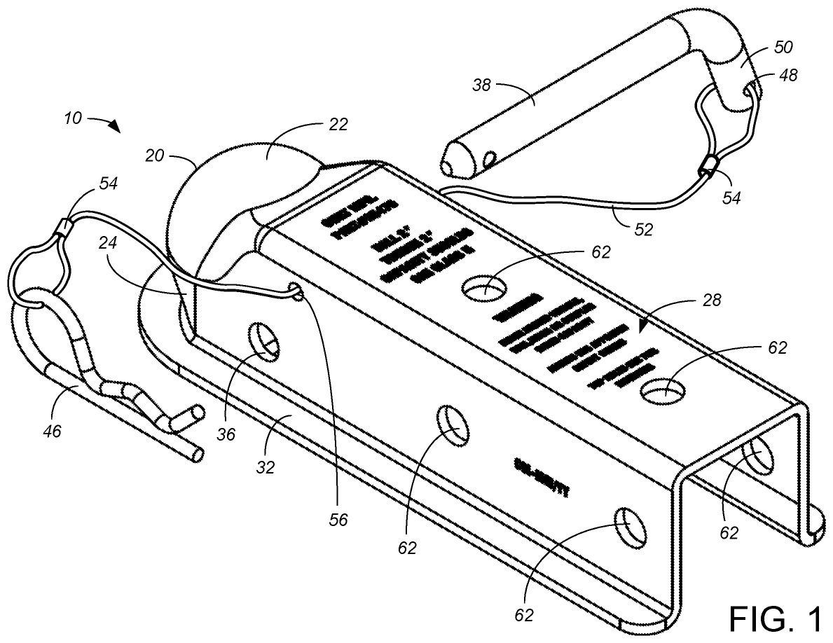

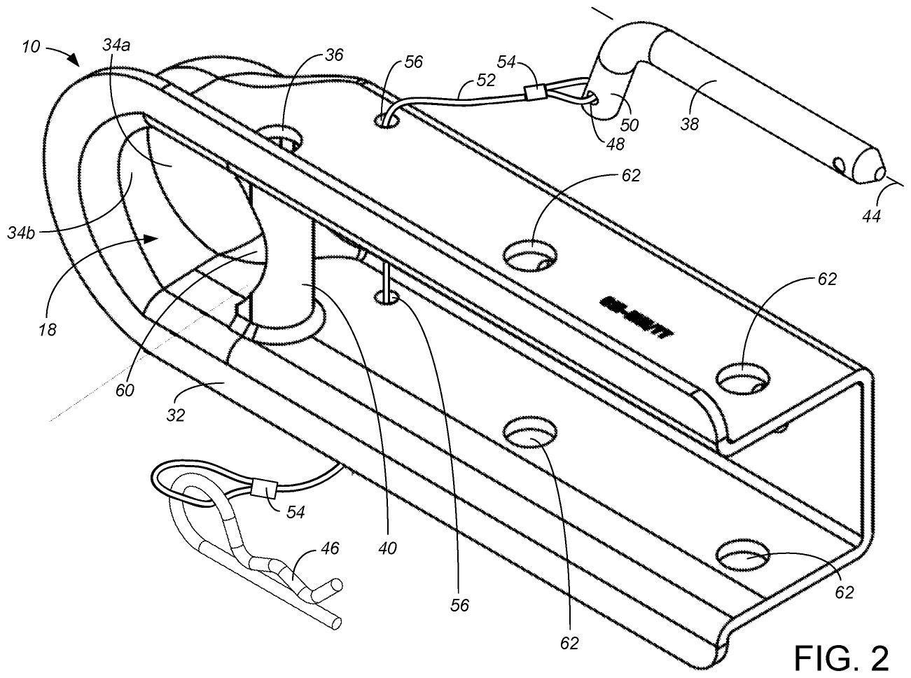

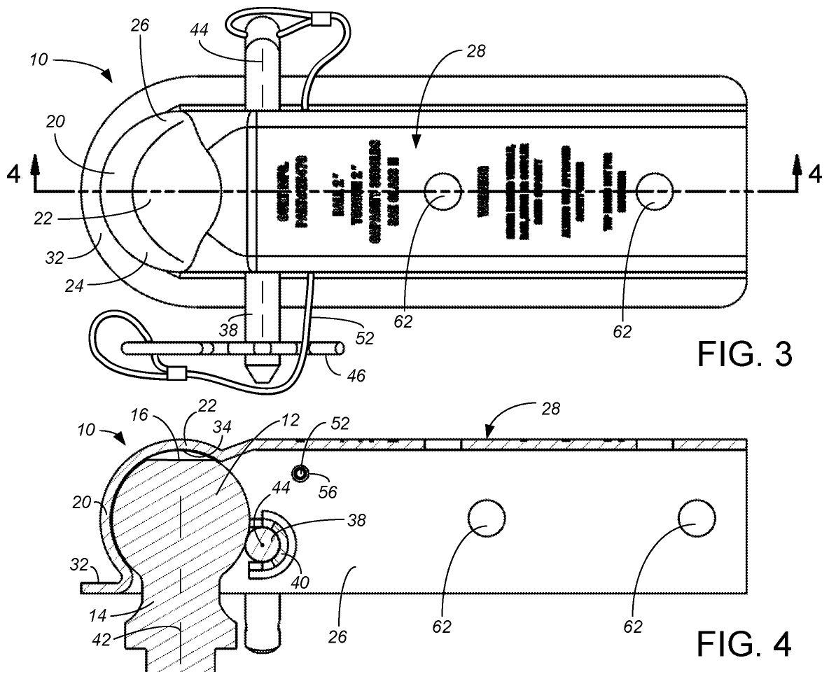

While the above-identified drawing figures set forth preferred embodiments, other embodiments of the present invention are also contemplated, some of which are noted in the discussion. In all cases, this disclosure presents the illustrated embodiments of the present invention by way of representation and not limitation. Numerous other minor modifications and embodiments can be devised by those skilled in the art which fall within the scope and spirit of the principles of this invention.

### DETAILED DESCRIPTION

The present invention is a trailer coupler 10, 110, 210, 310, 410, for use in attaching a trailer (not shown) to a tow ball 12 providing a generally spherical outer profile rising above a neck 14 mounted on the bumper, hitch or other structure (not shown) at the rear of a towing vehicle (not shown). Tow balls 12 are well known and common in countries such as the United States, with common tow ball sizes being 1⅞, 2 and 2 5/16 inches in spherical diameter rising above a neck diameter of about 1 or 1⅛ inches. Because tow ball location and orientation on towing vehicles is so common and accepted, directional terms used in the present application (such as “up”, “down”, “above”, “top”, “forward”, “rear”, “horizontal”, “vertical” etc.) all refer to the orientation of the trailer coupler 10, 110, 210, 310, 410 when connected and used on such a tow ball 12 based on the forward travel direction of the towing vehicle. The inventive couplers discussed herein could alternatively be used with tow balls oriented in different directions or in different locations on the towing vehicle, (for instance, some towing vehicles have a tow ball on the front of the vehicle, not shown), in which case the directional terms used in the present application should be adapted to conform with the tow ball orientation and location.

In many common tow balls 12, the top 16 of the ball 12 may be flattened and planar, and the planar top 16 may be about 1 inch in diameter. Providing such a planar top 16 of the tow ball 12 allows a visually-exposed surface which does not come into contact with the coupler 10, 110, 210, 310, 410 during use of the hitch, convenient for including information stamped, debossed or embossed on the tow ball 12 but much less likely to become marred during towing use of the hitch. Most trailers have a positive tongue weight which is supported by the tow ball 12 as a contact force on the spherical surface of the tow ball 12 above the tow ball equator and below the planar top 16. The towing force during acceleration is transmitted as a contact force on the forwardly facing surface of the tow ball 12 (i.e., the forwardly facing hemispherical surface of the tow ball 12, which exists in front of a bisecting plane transversely-oriented relative to the forward direction of vehicle travel). The towing force during braking deceleration is transmitted as contact force on the rearwardly facing surface of the tow ball 12 (i.e., the rearwardly facing hemispherical surface).

The preferred couplers 10, 110, 210, 310, 410 of the present invention all define a partially spherical recess 18, generally toward the front of the coupler 10, 110, 210, 310, 410. The recess 18 is between a front side wall 20 horizontally to the front of the tow ball 12, a top wall 22 extending vertically over at least a portion of the tow ball 12, a left side wall 24 horizontally to the left of the tow ball 12, and a right side wall 26 horizontally to the right of the tow ball 12. While openings could be formed in any of these walls permitting viewing of the tow ball therethrough, the preferred embodiments utilize continuous walls 20, 22, 24, 26 for more strength and more contact area with the tow ball 12. In the first four embodiments, the couplers 10, 110, 210, 310, have a coupler body 28, 128, 228, 328 providing all these walls 20, 22, 24, 26 and formed by stamping and bending of sheet metal material. In the fifth embodiment, the coupler 10, 110, 210, 310, 410 has a cast or forged coupler head 430 providing all these walls 20, 22, 24, 26. The most preferred material for the coupler body 28, 128, 228, 328 is carbon structural steel such as Q235, for which a thickness of about 3 mm is suitable. To provide additional strength in the towing direction, the preferred embodiments include a horizontally oriented bottom lip 32, having a width extending forwardly and around the sides for at least the thickness of the sheet material, but not extending so far as to interfere or contact the towing vehicle in front of the tow ball 12. In the preferred embodiments shown, the lip 32 has a width of about 15 mm. The most preferred material for the coupler head 430 is 1040 carbon steel, cast or forged to have a thickness in the range of 5-15 mm, and most preferably about 9-10 mm. At this thickness, no lip is necessary for the coupler head 430.

On the inside, the contact surface 34 of the recess 18 defines a spherical diameter which matches a common size of tow ball 12 with only a slight clearance, i.e., to ensure the tow ball 12 fits within the recess 18 without binding and subject to both tow ball tolerances and recess tolerances. Openings 36 are provided in side walls 24, 26 of the coupler body 28, 128, 228, 328 or coupler head 430 behind the ball 12 for transverse insertion of a latch pin 38. The latch pin 38 is supported by a latch pin reinforcement crossmember 40 which rigidly connects the side walls 24, 26 of the coupler head 430 or coupler body 28, 128, 228, 328.

In the quadrant above the tow ball equator and in front of the transversely-oriented bisecting plane containing the vertical tow ball axis 42, where the load transmission will occur during towing acceleration, the contact surface 34a of the recess 18 needs to be strong and robust, to transmit towing acceleration forces over years of use. While contact could occur in the upper-front quadrant over a smaller surface area, the upper-front quadrant 34a of the contact surface 34 in the preferred embodiments is designed to be entirely spherical, thereby spreading out the towing-acceleration force transmission as much as possible.

In the lower-front quadrant, the spherical contour 34b of the contact surface 34 of the coupler body 28, 128, 228, 328 preferably extends downward below the ball equator but not so low as to interfere with the neck 14 of the ball 12, even when traversing over valley troughs and ruts during towing. Having the front contact surface 34b extend below the ball equator helps to keep the ball 12 tight vertically within the recess 18 during towing while minimizing stress on the latch pin 38 and latch pin reinforcement crossmember 40. Having the front contact surface 34b extend below the ball equator also allows for slightly higher placement of the latch pin 38 and latch pin reinforcement crossmember 40 relative to the side walls 24, 26. For instance, the spherical contour 34b of the contact surface 34 of the coupler body 28, 128, 228, 328 should extend downward from 10 to 55°, and most preferably about 45°, below the ball equator before curving outward to form the lip 32. As used herein, all degree measurements are from the center of the tow ball 12 looking transversely. In the fifth embodiment using the coupler head 430, the contact surface 34 does not extend downward below the ball equator. This allows for an easier casting or forging operation, and also minimizes trailer fore-aft movement during coupling, but has drawbacks in terms of force transmission during towing.

In the preferred embodiments, the recess 18 is formed to also make contact with the spherical ball surface in the upper-rear quadrant 34c. Making contact with the tow ball 12 in the upper-rear quadrant 34c helps transmit towing forces during deceleration while minimizing stress on the latch pin 38 and latch pin reinforcement crossmember 40. Because recess contact with the tow ball 12 is limited to 180° to allow insertion and removal of the tow ball 12, how far the contact surface 34 extends in the upper-rear quadrant 34c is limited by how far downward the contact surface 34 extends in the lower-front quadrant 34b. In the first four preferred embodiments, the contact surface 34 extends in the upper-rear quadrant 34c down about 35° below the top of the recess 18, so the contact surface 34 wraps a total of about 170° around the ball 12. In the fifth preferred embodiment with the cast or forged head 430, the contact surface 34 in the upper-rear quadrant 34c wraps all the way down to the equator, i.e., so the contact surface 34 of the recess 18 wraps 180° and can make contact with the entirely of the ball contact surface above the equator.

The latch pin reinforcement crossmember 40 is positioned to extend between the right and left side walls 24, 26 of the coupler body 28, 128, 228, 328 or coupler head 430, behind the tow ball 12 and below the tow ball equator. In the first four preferred embodiments, the latch pin reinforcement crossmember 40 is separately formed and then welded in place relative to the coupler body 28, 128, 228, 328. Alternatively, the latch pin reinforcement crossmember 40 could have a threaded connection with the coupler body 28, 128, 228, 328 or could have ends which are bent or peened by pressure contact with a forming tool (similar to a rivet) to connect with the coupler body 28, 128, 228, 328. In the fifth preferred embodiment with the cast or forged coupler head 430, the latch pin reinforcement crossmember 40 is integrally formed with the coupler head 430. In each case, the connection between the latch pin reinforcement crossmember 40 and the side walls 24, 26 of the coupler body 28, 128, 228, 328 or coupler head 430 must be rigid and strong, to never become disconnected during years or decades of use (and abuse) of the coupler 10, 110, 210, 310, 410.

When the latch pin 38 is inserted through the latch pin holes 36 in the coupler body 28, 128, 228, 328 or coupler head 430 and supported by the latch pin reinforcement crossmember 40, the latch pin 38 should make contact with the trailing side of the ball 12 below the ball equator but above the neck 14, thereby holding the ball 12 into the recess 18. The latch pin reinforcement crossmember 40 defines where the axis 44 of the latch pin 38 will be located when inserted. For instance, the latch pin axis 44 may be from 10 to 45° below the tow ball equator, and more preferably from 10 to 25° below the tow ball equator, with the preferred embodiments placing the latch pin axis 44 about 13° below the tow ball equator. The preferred latch pins 38 are common ½ inch diameter cylindrical and angled hitch pins as known in the art for use with a cotter pin clip 46, with an additional hole 48 positioned in the hitch pin angle 50 for a lanyard 52. While the preferred embodiment utilize an angle hitch pin 38 to reduce inventory and cost, other types and shapes of latch pins could alternatively be used.

The preferred lanyard 52 is a flexible wire cable, perhaps nylon coated multi-stranded steel, with ends crimped 54 after insertion through the latch pin 38, through holes 56 in the side walls 24, 26 of the coupler 10, 110, 210, 310, 410, and through the cotter pin clip 46. When so assembled, the lanyard 52 connects the latch pin 38 and the cotter pin clip 46 to the coupler 10, 110, 210, 310, 410 so they don't get misplaced when not being used.

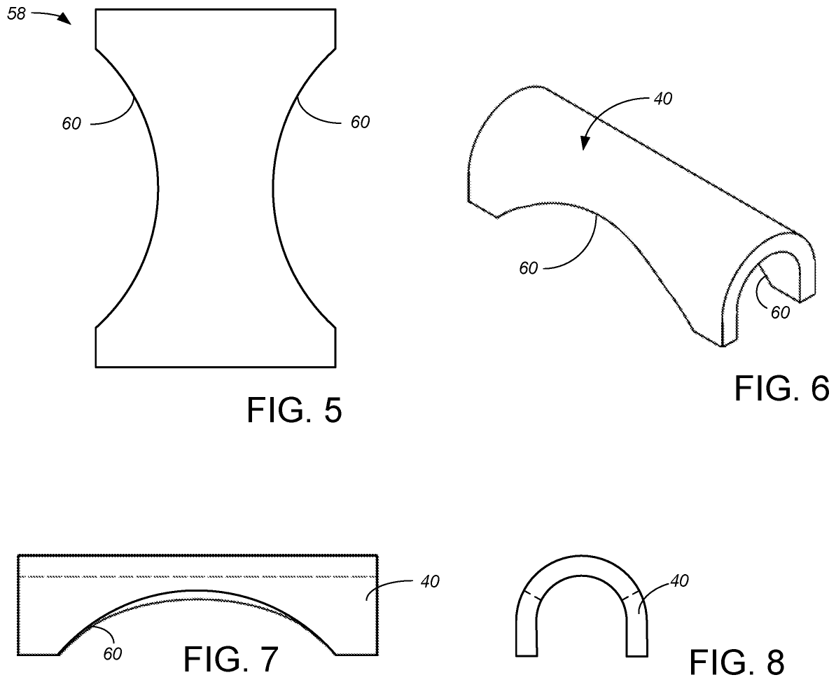

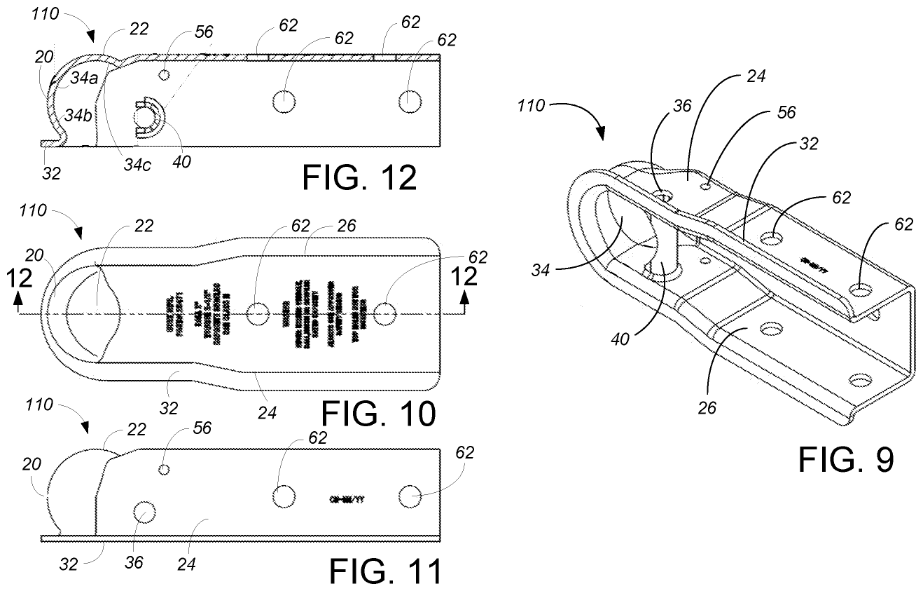

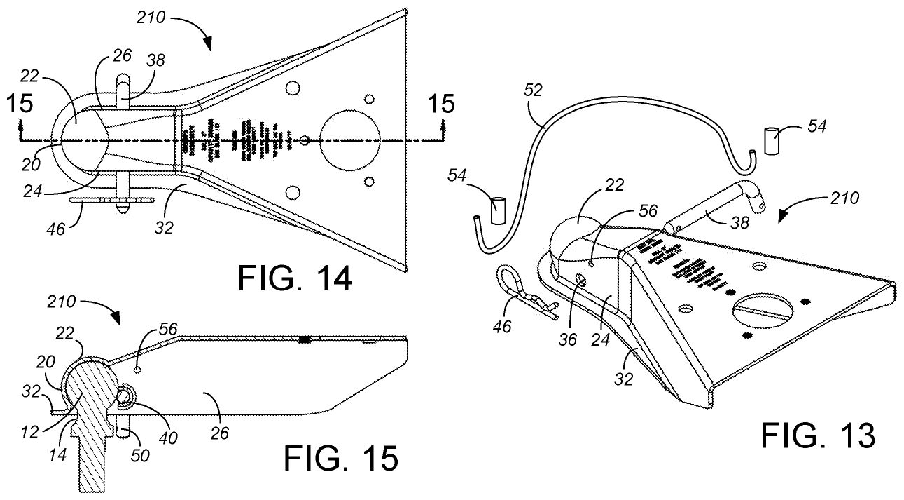

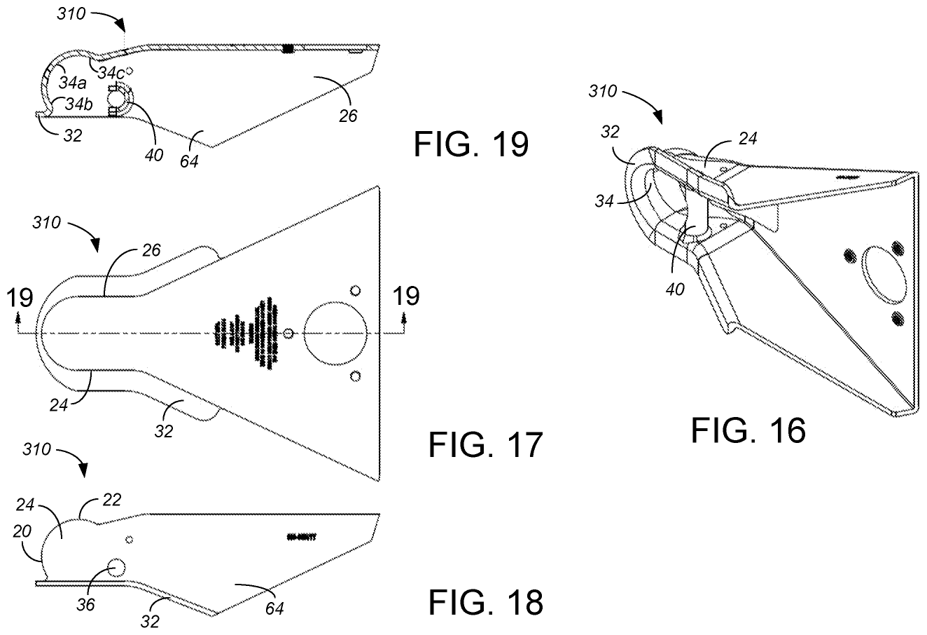

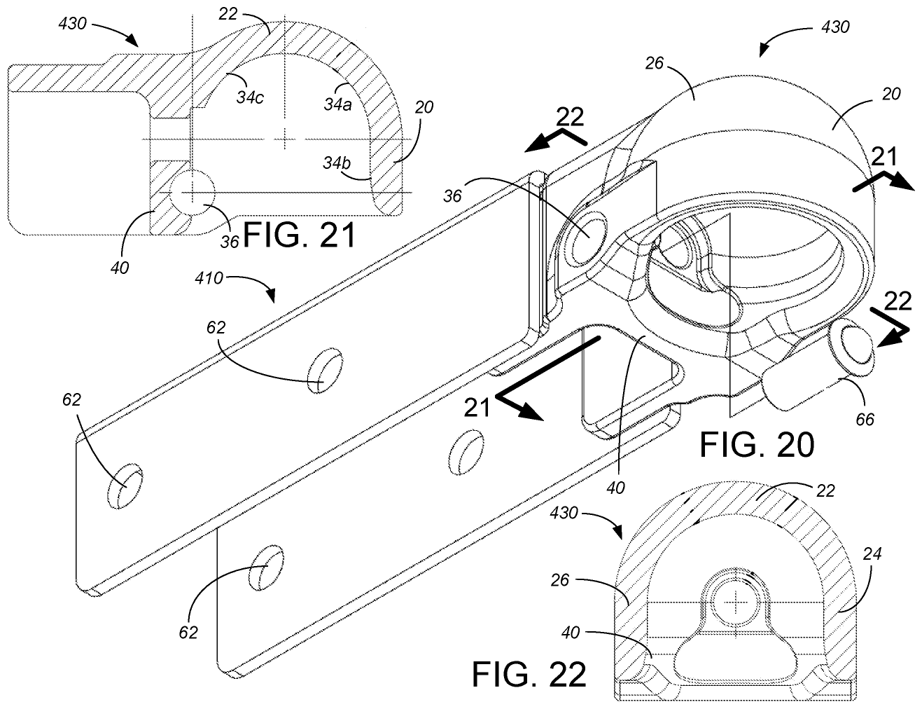

To achieve contact between the latch pin 38 and the tow ball 12, the latch pin reinforcement crossmember 40 must be open along its middle toward the ball 12. Additionally, the latch pin reinforcement crossmember 40 must be positioned and shaped to allow the tow ball 12 to pass through during insertion and removal of the tow ball 12 into/from the recess 18. In the first four preferred embodiments, the latch pin reinforcement crossmember 40 is formed by stamping and bending sheet metal material 58 as shown in FIGS. 5-8. Alternatively, the latch pin reinforcement crossmember 40 can be formed as a 360° tube with a lumen for the latch pin 38, or, as shown with the last embodiment, integrally formed as part of a coupler head 430.

The sheet material of the latch pin reinforcement crossmember 40 preferably matches the material of the coupler body 28, 128, 228, 328 both in type and thickness, particularly if the latch pin reinforcement crossmember 40 is to be connected to the coupler body 28, 128, 228, 328 by welding. The length of the latch pin reinforcement crossmember 40 preferably matches the length between the inner sides of the side walls 24, 26 of the coupler body 28, 128, 228, 328, which for the preferred embodiments is slightly larger than the diameter of the ball 12. Alternatively the length of the latch pin reinforcement crossmember 40 could be made longer and the latch pin openings in the side walls 24, 26 could be made larger, with the latch pin reinforcement crossmember 40 extending through the side walls 24, 26. Extending the latch pin reinforcement crossmember 40 through the side walls 24, 26 puts less stress on any welded connection, but can result in a less visually-appealing final product due to exposed welds and/or edges. Two arcuate notches 60 are preferably formed into the flat 58 prior to bending. The arcuate notches 60 preferably have a radius which is slightly larger than the radius of the intended tow ball 12. The arcuate notches 60 preferably have a width based on the bend amount around the latch pin 38 and the radius of the latch pin 38. In the preferred embodiments, the latch pin reinforcement crossmember 40 bends 180° around the latch pin axis 44, sized with a bend curvature slightly greater than the ½ inch diameter latch pin 38, with the arcuate notches 60 having a width of about 9 mm. During welding, the latch pin reinforcement crossmember 40 is oriented so the arcuate notches 60 are on the front, facing the recess 18.

The latch pin reinforcement crossmember 40 contacts and supports the latch pin 38 along its length, greatly absorbing stress and preventing the latch pin 38 from bending rearwardly due to towing forces over years or decades of use. The latch pin reinforcement crossmember 40 also rigidly connects the side walls 24, 26 of the coupler body 28, 128, 228, 328 or head 430 behind the tow ball 12, making it much less likely that the side walls 24, 26 could bend or bow outward over years or decades of use.

Use of the coupler 10, 110, 210, 310, 410 of the present invention is simple and straightforward. The coupler 10, 110, 210, 310, 410 is secured on the front of a trailer or other towed load, such as by using any or all of the bolt holes 62 shown. To connect the trailer to the tow ball 12, the user first removes the latch pin 38 from the openings 36. The coupler 10, 110, 210, 310, 410 is positioned over and downward onto the tow ball 12, with the tow ball 12 being fully advanced into the recess 18. Once the tow ball 12 is fully seated in the recess 18, the user merely slides the latch pin 38 horizontally into place by advancing the latch pin 38 along its axis 44 within the latch pin reinforcement crossmember 40. The user then secures the extended end of the latch pin 38 using the cotter pin clip 46. To disconnect the trailer from the tow ball 12, the steps are reversed in the opposite order. The present invention thus provides a structure and method which is intuitive and straight-forward to use, with no mechanisms to jam.

The first four embodiments differ from each other due to the shape of the coupler body 28, 128, 228, 328 behind the recess 18. In the first embodiment, the coupler body 28 is a straight channel version, in which the right and left side walls 24, 26 remain parallel and separated by the diameter of the recess 18. In the second embodiment, the right and left side walls 24, 26 of the coupler body 128 widen out, i.e., the channel for the trailer beam can be a different size—in this case wider—than the recess diameter. The third and fourth embodiments are A-frame versions 228, 328 for use with A-frame trailers. In the third embodiment, the lip 32 extends partially back into the A-frame widening of the side walls 24, 26. In the fourth embodiment, wings 64 are provided in the right and left side walls 24, 26 which drop down below the elevation of the lip 32.

In addition to being cast or forged rather than being formed by shaping sheet material, the fifth embodiment differs from the first four embodiments by including a spring ball plunger 66 as a detent. The spring ball plunger 66 is preferably positioned on the equator of the tow ball 12, pushing the tow ball 12 forward. The spring ball plunger 66 helps to correctly seat the tow ball 12 within the recess 18—thereby making insertion of the latch pin 38 easier, as well as helping to reduce rattle during towing. The spring ball plunger 66 could alternatively be used on any of the sheet metal versions.

All embodiments of the present application are relatively low in cost and light in weight. At the same time, the spherical shape around the front/top of the tow ball 12, and the support provided behind the tow ball 12 by the latch pin reinforcement crossmember 40, both help make the trailer coupler 10, 110, 210, 310, 410 strong and robust for years or decades of use.

Although the present invention has been described with reference to preferred embodiments, workers skilled in the art will recognize that changes may be made in form and detail without departing from the spirit and scope of the invention.

What is claimed is:

1. A trailer coupler for use with a tow ball, the tow ball defining a generally spherical outer profile extending above a neck, with the relationship between the generally spherical outer profile and the neck defining a generally vertical tow ball axis and a tow ball equator encircling the tow ball axis, the trailer coupler comprising:
a right side wall, a front side wall, a top wall and a left side wall collectively defining a recess sized to receive the tow ball placed therein, the recess having a contact surface for contacting the tow ball about the tow ball axis;
a latch pin opening defined colinearly through the right side wall and the left side wall;
a latch pin reinforcement crossmember, extending behind the recess from the right side wall to the left side wall and rigidly joined to the right side wall and to the left side wall, the hitch pin reinforcement member defining a channel extending generally horizontally below the tow ball equator; and
a latch pin which can be received in the channel of the latch pin reinforcement crossmember in an abutting relationship with the tow ball, such that the latch pin reinforcement crossmember will support the latch pin against deflection opposite the tow ball due to towing forces transmitted to or from the tow ball.

2. The trailer coupler of claim 1, wherein the right side wall, the front side wall, the top wall and the left side wall are jointly formed by bending of sheet metal material.

3. The trailer coupler of claim 2, wherein the latch pin reinforcement crossmember is welded to the left side wall and welded to the right side wall.

4. The trailer coupler of claim 3, wherein the latch pin reinforcement crossmember is formed by bending of a flat pattern of sheet metal material, the flat pattern comprising two arcuate notches sized so the tow ball can be inserted and removed to and from the recess without interference with the latch pin reinforcement crossmember.

5. The trailer coupler of claim 2, wherein the contact surface of the top wall extends downwardly behind a top of the recess.

6. The trailer coupler of claim 5, wherein the contact surface of the front side wall extends inwardly toward the tow ball axis beneath the tow ball equator.

7. The trailer coupler of claim 2, further comprising a lip extending horizontally at a bottom of the right side wall, front side wall and left side wall, at least partially around the tow ball axis.

8. . The trailer coupler of claim 2, wherein the right side wall, the top wall and the left side wall define a channel for receiving a beam of a trailer, and comprising one or more bolt openings through the right side wall, the top wall and the left side wall.

9. The trailer coupler of claim 1, wherein the contact surface of the front side wall extends inwardly beneath the tow ball equator.

10. The trailer coupler of claim 1, wherein the latch pin is attached to at least one of the walls with a lanyard.

11. The trailer coupler of claim 1, further comprising a spring ball plunger for biasing the tow ball forwardly into the recess.

12. The trailer coupler of claim 1, wherein the right side wall, the front side wall, the top wall and the left side wall are jointly formed by casting or forging, such that each of the right side wall, the front side wall, the top wall and the left side wall have generally the same, constant wall thickness.

13. A method of forming a trailer coupler for use with a tow ball, the tow ball defining a generally spherical outer profile extending above a neck, with the relationship between the generally spherical outer profile and the neck defining a generally vertical tow ball axis and a tow ball equator encircling the tow ball axis, the method comprising:
from sheet metal material, forming a right side wall, a front side wall, a top wall and a left side wall so as to collectively define a recess sized to receive the tow ball placed therein, the recess having a contact surface for contacting the tow ball about the tow ball axis;
forming a latch pin opening colinearly through the right side wall and the left side wall; and
rigidly attaching a latch pin reinforcement crossmember behind the recess from the right side wall to the left side wall, the latch pin reinforcement crossmember defining a channel extending generally horizontally below the tow ball equator, such that a latch pin can be received in the channel of the latch pin reinforcement crossmember in an abutting relationship with the tow ball, such that the latch pin reinforcement crossmember will support the latch pin against deflection opposite the tow ball due to towing forces transmitted to or from the tow ball.

14. The method of claim 13, wherein the latch pin reinforcement crossmember is attached to the left side wall and welded to the right side wall by welding.

15. The method of claim 14, wherein the latch pin reinforcement crossmember is formed by bending of a flat pattern of sheet metal material, the flat pattern comprising two arcuate notches sized so the tow ball can be inserted and removed to and from the recess without interference with the latch pin reinforcement crossmember.

16. The method of claim 15, wherein the sheet metal material of the latch pin reinforcement crossmember has the same thickness as the sheet metal material of the right side wall, the front side wall, the top wall and the left side wall.

17. The method of claim 13, further comprising bending the sheet metal material so as to form a lip extending horizontally at a bottom of the right side wall, the front side wall and the left side wall, at least partially around the tow ball axis.
